(19) United States
(12) Patent Application Publication
(10) Pub. No.: US 2021/0142937 A1
(43) Pub. Date: May 13, 2021

(54) Linear Actuation System Having Side Stators

(71) Applicant: ThermoLift, Inc., Stony Brook, NY (US)

(72) Inventor: Erik Kauppi, Ann Arbor, MI (US)

(73) Assignee: ThermoLift, Inc., Stony Brook, NY (US)

(21) Appl. No.: 16/605,143

(22) PCT Filed: Apr. 24, 2018
(86) PCT No.: PCT/US18/29223

§ 371 Date: Oct. 14, 2019

Related U.S. Application Data
(60) Provisional application No. 62/489,381, filed on Apr. 24, 2017.

(51) Int. Cl. H01F 7/16; H01F 7/08; H01F 7/18

(52) U.S. Cl. CPC H01F 7/1646; H01F 7/081; H01F 2007/185; H01F 7/1844; H01F 2007/086; H01F 7/1615

(57) ABSTRACT

A linear actuator is disclosed that is a double-ended solenoid with springs to provide much of the force for movement. The linear actuator can be used in a thermodynamic apparatus, such as a Vuilleumier heat pump in which two linear actuators are provided to drive two displacers. The linear actuator also has a cylindrical back iron section having first and second recesses with coils disposed in the recesses. The linear actuator assists in moving the armature from one end to the other and holds the armature at the end of travel. However, much of the force for moving the armature is provided by a spring exerting a force on the shaft with respect to the back iron section. In one embodiment, the spring is a compression-tension spring. Alternatively, two compression springs acting in opposition are provided.

### FIELD OF INVENTION

The present disclosure relates to linear actuators.

### BACKGROUND

Vuilleumier heat pumps have been known since the early 20th century. Such heat pumps, as disclosed in U.S. Pat. No. 1,275,507, have two displacers that separate the internal volume into hot, warm, and cold chambers. The displacers are crank driven with a 90 degree offset. In a more recent development, the displacers in the heat pump are by a mechatronic system, as described in commonly-assigned PCT/US16/57755. In FIG. 1, based on a figure in the '755 reference, a heat pump 100 has a hot displacer 102 and a cold displacer 104 that reciprocate within a cylinder 106. Displacers 102 and 104 are controlled by mechatronic actuators in the lower half of the heat pump 100. The actual connections are shown in FIG. 1, although not separately described. A hot displacer actuator 110 and a cold displacer actuator 120 are coupled to the hot and cold displacers 102 and 104, respectively. Each of actuators 110 and 120 have a ferromagnetic bucket, 116 and 126, respectively. Ferromagnetic buckets 116 and 126 act as armatures. Armature 116 has a plate portion that extends outwardly from a cylindrical portion through which a spring 124 passes and to which a spring 114 is coupled. Spring 114 is associated with hot displacer 102; and spring 124 is associated with cold displacer 104. An armature 126 has a plate portion and a cylindrical portion to which springs 114 and 124 are coupled. Springs 114 and 124 are, in this example, springs that go between compression and tension as the displacer to which it is coupled moves between ends of travel. Alternatively, two compression springs can be provided per displacer with the spring pair acting in opposition to each other.

Actuator 110 has coils 112 and 118 on either side of armature 116. When coil 112 is activated, armature 116 is attracted toward coil 112. When coil 112 is deactivated spring 114 causes armature 116 (and displacer 102) to move downward. If coil 118 is then activated, it attracts armature 116 toward coil 118. By deactivating coil 118, spring 114 causes armature 116 to move toward coil 112. By acting on armature 116 coupled to displacer 102, displacer 102 is caused to reciprocate between two ends of travel within cylinder 106. Similarly, displacer 104 is caused to reciprocate between its two ends of travel by judicious actuation of coils 122 and 128 that are disposed on either side of armature 126.

Herein, coils 112, 118, 122, and 128 are disposed in back irons 113, 119, 123, and 129. Back iron 113 and coil 112 make up a stator, called a face stator, herein. Similarly, coil 118 with back iron 119, coil 122 with back iron 123, and coil 128 with back iron 129 form stators. The face stators exert an attractive force on their respective armature (116 or 126) in a direction that is substantially in a direction parallel to a central axis 108 of heat pump 100.

In heat pump 100, displacers 102 and 104 separate the volume with cylinder 106 into four volumes: a hot volume 140, a hot-warm volume 142, a cold-warm volume 144, and a cold volume 146.

FIG. 1 shows an example a full heat pump. As the present disclosure is about linear actuation, a simplified drawing of a linear actuator to drive a single displacer, or any other reciprocating member, is illustrated in FIG. 2. A cylinder 10 having a central axis 25 has a displacer 12 disposed therein. Displacer 12 is coupled to a shaft 14 that is coupled to a plate, which acts as an armature 16. Displacer 12, shaft 14, and armature 16 reciprocate within cylinder 10. A first face stator, which includes a coil 20 disposed in a recess in a back iron section 18, is coupled to or affixed to cylinder 10 above armature 16. A second face stator, which includes coil 22 disposed in a recess in a back iron section 19, is coupled to or affixed to cylinder 10 below armature 16. Compression springs 36 and 38 act on armature 16 in opposition to each other. When coil 20 is activated by providing current, armature 16 is drawn toward coil 20 and spring 36 is further compressed while spring 38 is less compressed. When coil 20 is deactivated, the more compressed spring 36 pushes on armature 16 causing it to travel toward coil 22. Coil 22, if activated, pulls armature 16 in and holds armature 16 until coil 22 is deactivated. Spring 36 is provided around shaft 14 and held between a bridge 30 that extends across cylinder 10. Bridge 30 has an opening 32 that is slightly greater in diameter than an outer diameter of shaft 14 to allow shaft 14 to reciprocate therethrough and to provide guidance for shaft 14. Spring 36 is captured between armature 16 and bridge 30. Armature 16 doesn't have a shaft extending downwardly, so a solid bridge 34 can be provided across cylinder 10 to capture spring 38 between armature 16 and bridge 34. In alternative embodiments, bridge 34 has a central opening to accommodate a shaft or other components.

Problems encountered with the type of linear actuation system shown in FIGS. 1 and 2 include a very large current through the coil to attract the ferromagnetic plate or armature when it is far away from the coil; and the difficulty in controlling the trajectory so that the displacer approaches the far end of travel and does so with an acceptably low impact speed to achieve a soft landing to thereby minimize noise. In FIG. 3, the attractive force as a function of the gap between the coil and the armature is shown for a range of current levels. At a small gap, for a given current level, the attractive force is great. As the gap is greater, the attractive force is very small. To have an effect on an armature that is far away, the current applied must be great. Another solution is to provide a coil with more windings; however, this is limited by packaging constraints and transient response of the coils.

### SUMMARY

To overcome at least one problem in the prior art, a linear actuator is disclosed that can be used in a thermodynamic apparatus, such as a Vuilleumier heat pump. The linear actuator has an armature coupled to a shaft, which in turn is coupled to a displacer in a cylinder. The linear actuator also has a cylindrical back iron section having first and second recesses with coils disposed in the recesses. The linear actuator assists in moving the armature from one end to the other and holds the armature at the end of travel. However, much of the force for moving the armature is provided by a spring exerting a force on the shaft with respect to the back iron section. In one embodiment, the spring is a compression-tension spring. In another embodiment, the spring is a first compression spring and a second compression spring acting in opposition to the first spring.

A linear actuator is disclosure that has a substantially cylindrical back iron section having a central axis, the back iron section having at least first and second recesses defined therein, with the first recess displaced from the second recess in a direction parallel to the central axis, a first side coil disposed in the first recess, a second side coil disposed in the second recess, and an armature disposed within the back iron, the armature being free to move along the central axis between a first end of travel and a second end of travel.

The actuator also has a shaft coupled to the armature and a spring system having a first end coupled to the armature and second end coupled to the back iron section. The coupling between the spring system and the armature is one of direct and indirect. The coupling between the spring system and the cylindrical back iron section is one of direct and indirect. There may be intermediary components between the spring system and the armature, which is a moving element, and between the spring system and the stationary back iron section.

The armature, in some embodiments, includes a radially-symmetric permanent magnet and to ferromagnetic, radially-symmetric pole pieces coupled to the permanent magnets. The two pole pieces abut the permanent magnet and are mutually separated.

The linear actuator, in some embodiments, includes a shaft coupled to the armature. The armature has first and second substantially-annular pole pieces coupled to the shaft and an annular permanent magnet with a first face of the permanent magnet abutting a face of the first pole piece and a second face of the permanent magnet abutting a face of the second pole piece, the first pole piece being separated from the second pole piece.

The shaft is magnetically insulated from: the first pole piece, the second pole piece, and the permanent magnet. In one embodiment, the shaft is made of a substantially non-magnetic material. In another embodiment, a magnetically insulating element is interposed between the shaft and the first pole piece, the second pole piece, and/or the permanent magnet.

In some embodiments, the linear actuator includes a first substantially disk-shaped back iron section abutting the cylindrical back iron section proximate a first end of the cylindrical back iron section and a second substantially disk-shaped back iron section abutting the cylindrical back iron section proximate a second end of the cylindrical back iron section. The first and second disk-shaped back iron sections and the cylindrical back-iron section form a back iron.

In some embodiments the spring system is made up of a single compression-tension spring. In other embodiments, the spring system has two or more nested springs. First ends of the springs are mounted in a first common element, which could be a stationary piece coupled directly or indirectly to the back iron section. Second ends of the springs are mounted in a second common element, which could be a moving piece coupled directly or indirectly to the armature or a shaft coupled to the armature or other common element. In yet another embodiment, the spring system includes a pair of compression springs that are mutually biased against each other.

The linear actuator system includes a power electronics module electrically coupled to first and second side coils and an electronic control unit (ECU) 80 electronically coupled to the power electronics module. The ECU determines a desired trajectory of the armature, computes a current to provide to the first and second side coils, and commands the power electronic module to deliver such current to the first and second side coils. In some embodiments, a user input is provided to the ECU via electronic coupling. A position sensor is electronically coupled to the ECU. The position sensor, in some embodiments, determines the position of the armature. The ECU computes the desired trajectory of the armature based at least on user input and a signal from the position sensor. Herein, electronically coupled can be via any suitable wired or wireless structures or protocols.

The linear actuator has a back iron that may be formed of multiple, contiguous sections, one of which is the cylindrical back iron or can be a unitary piece.

Also disclosed in an apparatus in which the linear actuator is disposed. The apparatus has a cylinder having a central axis, a reciprocating component disposed in the cylinder, a shaft coupled to the reciprocating component and the linear actuation system. The linear actuation system has: an armature coupled to the shaft, a substantially cylindrical back iron section having a first and second recesses defined therein, a first coil disposed in the first recess, a second coil disposed in the second recess, and a spring system exerting a force on the shaft with respect to the back iron section, the force being in a direction parallel to the central axis. The armature has a first end of travel and a second end of travel. A path of travel from the first end to the second end is parallel to the central axis of the cylinder.

The apparatus further includes a first disk-shaped back iron section delimiting the armature travel at the first end of travel and a second disk-shaped back iron section delimiting the armature travel at the second end of travel. The first disk-shaped back iron section abuts the cylindrical back iron at a first end of the cylindrical back iron. The second disk-shaped back iron section abuts the cylindrical back iron at a second end of the cylindrical back iron.

The first recess overlaps the first disc-shaped back iron section as considered axially. The second recess overlaps the second disc-shaped back iron section as considered axially.

The substantially cylindrical back iron section has a plurality of contiguous sections.

The spring system includes a first compression spring and a second compression spring exerting a force on the shaft with respect to the back iron section. The force of the second compression spring acting in a direction opposite to the direction of the force of the first compression spring.

In some embodiments, the spring system is a compression-tension spring. The force exerted by the spring on the shaft is in a first direction parallel to the central axis when the armature is at the first end of travel. The force exerted by the spring on the shaft is in a second direction parallel to the central axis when the armature is at the second end of travel. The first direction is opposite the second direction.

In some embodiments, the armature has first and second substantially-annular pole pieces coupled to the shaft and an annular permanent magnet with a first face of the permanent magnet abutting a face of the first pole piece and a second face of the permanent magnet abutting a face of the second pole piece. The first pole piece is separated from the second pole piece. The first pole piece, the second pole piece, and the permanent magnet are magnetically isolated from the shaft.

The apparatus has a position sensor coupled to the apparatus that senses position of the reciprocating component. Because the reciprocating component is coupled to the armature, the position sensor also senses position of the armature. The apparatus includes an electronic control unit (ECU) electronically coupled to the position sensor and a power electronics module electronically coupled to the ECU and electrically coupled to the first and second coils. The ECU commands the power electronics module to provide current to the coils based at least on a signal from the position sensor.

Also disclosed is a thermodynamic apparatus that has: a first cylinder having a central axis, a second cylinder have a central axis, a first displacer disposed in the first cylinder, a second displacer disposed in the second cylinder, a first shaft coupled to the first displacer, a second shaft coupled to the second displacer, and a second linear actuation system. The first linear actuation system includes a first substantially-cylindrical back iron section defining first and second recesses with the first recess displaced from the second recess along a direction parallel to the central axis of the first cylinder, first and second coils disposed in the first and second recesses, a first armature located within the first back iron section and coupled to the first shaft, and a first spring system coupled between the first back iron section and the first armature. The first spring system exerting a relative force between the first back iron section and the first armature in a direction substantially parallel to the central axis of the first cylinder. The second linear actuation system includes: a second substantially-cylindrical back iron section defining third and fourth recesses with the third recess displaced from the fourth recess along a direction parallel to the central axis of the second cylinder, third and fourth coils disposed in the third and fourth recesses, a second armature located within the second back iron section and coupled to the second shaft, and a second spring system coupled between the second back iron section and the second armature, the second spring exerting a relative force between the second back iron section and the second armature in a direction substantially parallel to the central axis of the second cylinder.

The thermodynamic apparatus, in some embodiments has: a first disk-shaped back iron section delimiting the first armature travel at a first end of travel within the first cylindrical back iron, a second disk-shaped back iron section delimiting the first armature travel at a second end of travel within the first cylindrical back iron, a third disk-shaped back iron section delimiting the second armature travel at a first end of travel within the second cylindrical back iron, and a second disk-shaped back iron section delimiting the first armature travel at a second end of travel within the second cylindrical back iron. The first disk-shaped back iron section abuts the first cylindrical back iron at a first end of the first cylindrical back iron. The second disk-shaped back iron section abuts the first cylindrical back iron at a second end of the first cylindrical back iron. The third disk-shaped back iron section abuts the second cylindrical back iron at a first end of the second cylindrical back iron. The fourth disk-shaped back iron section abuts the second cylindrical back iron at a second end of the second cylindrical back iron.

The first spring is a first spring system has first and second compression springs biased against other. The second spring system has third and fourth compression springs biased against each other.

The first spring system is a first compression-tension spring and the second spring system is a second compression-tension spring.

The thermodynamic apparatus also includes: a first position sensor coupled to the thermodynamic apparatus that senses the position of the first displacer, a second position sensor coupled to the thermodynamic apparatus that senses the position of the second displacer, an electronic control unit (ECU) electronically coupled to the first position sensor and the second position sensor, and a power electronics module electronically coupled to the ECU and electrically coupled to the first, second, third, and fourth coils.

Each of the first and second armatures has first and second substantially-annular pole pieces coupled to the shaft and an annular permanent magnet with a first face of the permanent magnet abutting a face of the first pole piece and a second face of the permanent magnet abutting a face of the second pole piece. The first pole piece is separated from the second pole piece. The first pole piece, the second pole piece, and the permanent magnet are magnetically isolated from the shaft.

At least one of the substantially cylindrical back iron sections is made up of a plurality of contiguous sections.

### BRIEF DESCRIPTION OF DRAWINGS

FIG. 1 is a schematic of an actuation system for a displacer of a gas-fired heat pump according to the prior art;

FIG. 2 is a schematic of a linear actuation system of the type in FIG. 1 with one linearly moving component, i.e., a single displacer;

FIG. 3 is a graph of the force of a coil on attracting an armature as a function of gap between the two;

FIG. 4 is an illustration of a linear actuation system for a single linearly moving component according to the present disclosure;

FIG. 5 is a graph of force applied to an armature having a permanent magnet as a function of current provided to a side stator; and

FIG. 6 shows a linear actuator with end coils;

FIG. 7 shows a linear actuator with side coils; and

FIG. 8 is an illustration of one type of spring system.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

A linear actuator system 48 system is shown FIG. 4 in cross section. A displacer 52, or other member, reciprocates within a cylinder 50 that has a centerline 51. Displacer 52 is coupled to a shaft 54 that has an armature that extends outwardly from post 54. The armature is made up of a permanent magnet 96, pole pieces 94 that sandwich permanent magnet 96, and insulators 92. Armature is magnetically isolated from shaft 54 by insulator 92. Alternatively, shaft 54 is a non-ferromagnetic material and such insulators are not provided. A shaft 55 extends from the armature (elements 92, 94, and 96) in an opposite direction than shaft 54. Bridges 70 and 74 extend across cylinder 50 and define a volume in which back iron sections 44, 46, and 56 are disposed. A coil 60 disposed in a first recess in back iron section 56 is a first side stator; and coil a 62 in a second recess in back iron section 56 is a second side stator. Back iron section 56, in an alternative embodiment, is made up of two back iron sections. Contiguous back iron sections 44, 46, and 56 together form a back iron. Many alternatives are contemplated that include more or fewer sections to form the back iron.

Coils 60 and 62 are located near the end of travel of the armature so that they are able to hold the armature 56 for a dwell period. This obviates face stators 24 and 26 such as shown in FIG. 2. Coils 60 and 62, which form side stators, are also able to affect movement of armature 56 during mid-travel better than coils 20 and 22 of FIG. 2 because coils 60 and 62 are closer to the armature during mid-travel than coils 20 and 22 of FIG. 2.

If movement of the displacer system (displacer 52, shaft 54, the armature (elements 92, 94, and 96) shaft 55, and plate 76, which is coupled to shaft 55) were driven solely by activating coils 60 and 62, the electrical draw can be very high. Much of the force to move the displacer system is provided by a spring 78 which is affixed to bridge 74, which is in turn affixed to cylinder 50, and affixed to plate 76 which moves within cylinder 50. When the armature is at the top of travel, i.e., proximate coil 60, spring 78 is in compression. When the armature is at the bottom of travel, i.e., proximate back iron section 46, spring 78 is in tension. Consequently, when armature 90 is at the top of travel, spring 78 pushes on plate 76 to cause displacer 52 to move downward when coil 60 is deactivated. And, when the armature is at the bottom of travel, spring 78 pulls upward on plate 76 to cause displacer 52 to move upward when coil 62 is deactivated. Spring 78 provides much of the force to move the displacer system between ends of travel. The force provided by spring 78 cannot be controlled. Side coils 60 and 62 provide additional force during travel, such force being controllable to ensure completing the travel and approaching the end of travel slowly enough to avoid impact.

The armature in FIG. 4 includes an insulator 92 that magnetically isolates shafts 54 and 55 from the armature. Armature 90 includes a permanent magnet 96 sandwiched between pole pieces 94, which are ferromagnetic blocks. Pole pieces 94 are flux carriers that move proximate a wall of back iron section 56 with a small air gap between an outer end of pole pieces 94 and an inner surface of back iron section 56.

In FIG. 4, an electronic control unit (ECU) 80 is electronically coupled to a position sensor 82 and other sensors 84 that may include pressure and temperature sensors, as examples. Furthermore, ECU 80 may be provided user input 85, such as a desired output from system 48. ECU 80 provides a signal or signals to a power electronics module 86 that is electrically coupled to coils 60 and 62. Module 86 is provided to control the current flow to coils 60 and 62 to obtain the desired travel of displacer 52. ECU 80 signals to power electronics module 86 are based on one or more of user input, a signal from position sensor 82, and signals from other sensors 84.

Armature 90 has a permanent magnet 96. When current in one direction is provided to a coil, it attracts armature 90. However, when current in the opposite direction is provided to the coil, it repels armature 90. During travel of armature 90 between ends of travel, a signal from position sensor 82 can be used to determine whether the armature is predicted to reach the end of travel or not and at what impact speed. Current can be provided to coils 60 or 62 in either direction to provide attractive or repulsive force acting on armature 90. A graph of force that can be provided as a function of distance between the armature and the stator is shown in FIG. 5. When there is no current, due to the armature having a permanent magnet, the attractive force is shown as dashed line 500. Current applied to the coil in a first direct yields curve 502. Current of the same magnitude in the opposite direction causes a repulsive force, curve 504. Providing a repulsive force allows for the following control options: braking, so as to prevent a hard impact when the armature is approaching the end of travel; braking for electrical energy recovery (which might be useful for some operating conditions of a heat pump); and for pushing off the armature from an end of travel.

Obtaining reliable operation of the linear actuation system such as shown in FIG. 1 was a concern as well as the high electrical energy demand. Such electrical energy demand impairs the overall efficiency of the heat pump. The parasitic losses to the electrical energy demand of the face coil design (FIG. 2) may be inherent. The present disclosure of a side coil design (FIG. 4) is to diminish such parasitic losses.

A less complicated illustration of the salient features of the coils and armature portion of a linear actuator is shown in FIGS. 6 and 7 showing face coils 202 in back iron 200 and side coils 212 in back iron 210, respectively. Coils 202 act on ferromagnetic armature 206 in FIG. 6. Armature 218 in FIG. 7 is made up of pole pieces 214 and a permanent magnet 216. Alternatively, the configuration of FIG. 7 could have an armature such as that shown in FIG. 6, although would have less capability. A permanent magnet, which provides the possibility for attractive and repulsive forces. Repulsion, achieved by reversing the current in the coil, provides another degree of freedom in control, thereby permitting smooth landing, another issue yet unresolved in the design with face stators. Additionally, at some operating conditions, electrical energy may be extracted during part of the cycle to provide energy for other parts of the cycle. Because coils 212 of FIG. 7 are located nearer armature 218 along the travel path (as compared to coils 202 in relation to armature 016, coils 212 provide mid-travel assist and better control as well as more than sufficient holding current at the ends of travel.

Because the side stators are located nearer the armature along the travel path (as shown in FIG. 6), they provide mid-travel assist and control as well as more than sufficient holding current at the ends of travel. Significantly, the Gen 3.0 armature includes a permanent magnet, which provides the possibility for attractive and repulsive forces. Repulsion, achieved by reversing the current in the coil, provides another degree of freedom in control, thereby permitting smooth landing, another issue yet unresolved in the design with face stators. Additionally, at some operating conditions, electrical energy may be extracted during part of the cycle to provide energy for other parts of the cycle. A conservative estimate indicates parasitic losses for linear actuation drops 60%. Such a decrease in parasitic losses has a substantial positive impact on overall efficiency of the system.

There are several options for the spring system. A single, machined spring such as spring 78 in FIG. 4 is one option. Alternatively, the spring system shown in FIG. 1 is another option. A first spring system acts upon ferromagnetic bucket 116. The first spring system includes first and second compression springs 170 and 172 that are biased against each other. The second spring system includes third and fourth compression springs 180 and 182 that are biased against each other and act upon ferromagnetic bucket 126. Another compression-tension option is a spring system shown in FIG. 8. A first spring 240 has a first hook with an end that couples to a first common element 248. A second spring 250 has an opposite sense as first spring 240. Second spring has a hook 252 that couples to first common element 248. At the other ends of springs 240 and 250 are hook ends 244 and 254, respective, both of which couple to a second common element 246. Common elements 246 and 248 prevent relative rotation of hooks ends 242 and 252 and of hook ends 244 and 254, respectively. Common element 248 has an orifice 256 through which a shaft or other element may pass. Springs 240 and 250 and common elements 248 and 246 substantially share a common central axis 260.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

1. A linear actuator, comprising:
a substantially cylindrical back iron section having a central axis, the back iron section having at least first and second recesses defined therein, with the first recess displaced from the second recess in a direction parallel to the central axis;
a first side coil disposed in the first recess;
a second side coil disposed in the second recess;
an armature disposed within the back iron, the armature being free to move along the central axis between a first end of travel and a second end of travel; and
a spring system coupled to the armature, wherein:
the spring system exerts a force on the armature with respect to the cylindrical back iron section;
the force is in a direction parallel to the central axis; and
the first and second side coils are located radially outside of the path of travel of armature when moving from the first end of travel to the second end of travel.

2. The linear actuator of claim 1, further comprising:
a shaft coupled to the armature,
wherein:
the coupling between the spring system and the armature is one of direct and indirect; and
the coupling between the spring system and the cylindrical back iron section is one of direct and indirect.

3. The linear actuator of claim 1 wherein:
the armature is comprised of a radially-symmetric permanent magnet and two ferromagnetic, radially-symmetric pole pieces; and
the two pole pieces abut the permanent magnet and are mutually separated.

4. The linear actuator of claim 1, further comprising:
a shaft coupled to the armature, wherein the armature comprises:
first and second substantially-annular pole pieces coupled to the shaft; and
an annular permanent magnet with a first face of the permanent magnet abutting a face of the first pole piece and a second face of the permanent magnet abutting a face of the second pole piece, the first pole piece being separated from the second pole piece.

5. The linear actuator of claim 4 wherein the shaft is magnetically insulated from: the first pole piece, the second pole piece, and the permanent magnet by one of:
the shaft being made of a substantially non-magnetic material; and
a magnetically insulating element interposed between the shaft and at least one of: the first pole piece, the second pole piece, and the permanent magnet.

6. The linear actuator of claim 1, further comprising:
a first substantially disk-shaped back iron section abutting the cylindrical back iron section proximate a first end of the cylindrical back iron section; and
a second substantially disk-shaped back iron section abutting the cylindrical back iron section proximate a second end of the cylindrical back iron section wherein the first and second disk-shaped back iron sections and the cylindrical back-iron section form a back iron.

7. The linear actuator of claim 1 wherein the spring system comprises one of the following:
a single compression-tension spring:
a plurality of nested springs with first ends of the springs mounted in a first common element and second end of the springs mounted in a second common element; and
a pair of compression springs that are mutually biased against each other.

8. The linear actuator of claim 1, further comprising:
a power electronics module electrically coupled to first and second side coils; and
an electronic control unit (ECU) electronically coupled to the power electronics module wherein:
the ECU determines a desired trajectory of the armature; computes a current to provide to the first and second side coils; and commands the power electronic module to deliver such current to the first and second side coils.

9. The linear actuator of claim 84, further comprising:
a user input electronically coupled to the ECU; and
a position sensor electronically coupled to the ECU wherein the ECU computes the desired trajectory of the armature based at least on user input and a signal from the position sensor.

10. (canceled)

11. An apparatus, comprising:
a cylinder having a central axis;
a reciprocating component disposed in the cylinder;
a shaft coupled to the reciprocating component; and
a linear actuation system, comprising:
an armature coupled to the shaft, the armature having a first end of travel and a second end of travel, a path of travel from the first end to the second end being parallel to the central axis of the cylinder;
a substantially cylindrical back iron section having first and second recesses defined therein;
a first coil disposed in the first recess;
a second coil disposed in the second recess; and
a spring coupled to the shaft, wherein:
the spring exerts a force on the shaft with respect to the cylindrical back iron section; and
the force being in a direction parallel to the central axis.

12. The apparatus of claim 11, further comprising:
a first disk-shaped back iron section delimiting the armature travel at the first end of travel; and
a second disk-shaped back iron section delimiting the armature travel at the second end of travel wherein:
the first disk-shaped back iron section abuts the cylindrical back iron at a first end of the cylindrical back iron; and
the second disk-shaped back iron section abuts the cylindrical back iron at a second end of the cylindrical back iron.

13. The apparatus of claim 11 wherein the substantially cylindrical back iron section is comprised of a plurality of contiguous sections.

14. The apparatus of claim 11 wherein the spring is a first compression spring, the apparatus further comprising:
a second compression spring exerting a force on the shaft with respect to the cylindrical back iron section, the force of the second compression spring acting in a direction opposite to the direction of the force of the first compression spring.

15. The apparatus of claim 11 wherein:
the spring is a compression-tension spring;
the force exerted on the shaft is in a first direction parallel to the central axis when the armature is at the first end of travel;
the force exerted on the shaft is in a second direction parallel to the central axis when the armature is at the second end of travel; and
the first direction is opposite the second direction.

16. The apparatus of claim 11 wherein:
the armature comprises:
first and second substantially-annular pole pieces coupled to the shaft; and
an annular permanent magnet with a first face of the permanent magnet abutting a face of the first pole piece and a second face of the permanent magnet abutting a face of the second pole piece, wherein:
the first pole piece is separated from the second pole piece; and
the first pole piece, the second pole piece, and the permanent magnet are magnetically isolated from the shaft.

17. The apparatus of claim 11, further comprising:
a position sensor coupled to the apparatus that senses position of the reciprocating component;
an electronic control unit (ECU) electronically coupled to the position sensor; and the for
a power electronics module electronically coupled to the ECU and electrically coupled to the first and second coils wherein the ECU commands the power electronics module to provide current to the coils based at least on a signal from the position sensor.

18. A thermodynamic apparatus, comprising:
a first cylinder having a central axis;
a second cylinder have a central axis;
a first displacer disposed in the first cylinder;
a second displacer disposed in the second cylinder;
a first shaft coupled to the first displacer;
a second shaft coupled to the second displacer;
a first linear actuation system, comprising:
a first substantially-cylindrical back iron section defining first and second recesses with the first recess displaced from the second recess along a direction parallel to the central axis of the first cylinder;
first and second coils disposed in the first and second recesses;
a first armature located within the first back iron section and coupled to the first shaft; and
a first spring coupled between the first back iron section and the first armature, the first spring exerting a relative force between the first back iron section and the first armature in a direction substantially parallel to the central axis of the first cylinder; and
a second linear actuation system, comprising:
a second substantially-cylindrical back iron section defining third and fourth recesses with the third recess displaced from the fourth recess along a direction parallel to the central axis of the second cylinder;
third and fourth coils disposed in the third and fourth recesses;
a second armature located within the second back iron section and coupled to the second shaft; and
a second spring coupled between the second back iron section and the second armature, the second spring exerting a relative force between the second back iron section and the second armature in a direction substantially parallel to the central axis of the second cylinder.

19. The thermodynamic apparatus of claim 18, further comprising:
a first disk-shaped back iron section delimiting the first armature travel at a first end of travel within the first cylindrical back iron;
a second disk-shaped back iron section delimiting the first armature travel at a second end of travel within the first cylindrical back iron;
a third disk-shaped back iron section delimiting the second armature travel at a first end of travel within the second cylindrical back iron;
a second disk-shaped back iron section delimiting the first armature travel at a second end of travel within the second cylindrical back iron wherein:
the first disk-shaped back iron section abuts the first cylindrical back iron at a first end of the first cylindrical back iron;
the second disk-shaped back iron section abuts the first cylindrical back iron at a second end of the first cylindrical back iron;
the third disk-shaped back iron section abuts the second cylindrical back iron at a first end of the second cylindrical back iron; and
the fourth disk-shaped back iron section abuts the second cylindrical back iron at a second end of the second cylindrical back iron.

20. The thermodynamic apparatus of claim 18, further comprising:
a first position sensor coupled to the thermodynamic apparatus that senses the position of the first displacer;
a second position sensor coupled to the thermodynamic apparatus that senses the position of the second displacer;
an electronic control unit (ECU) electronically coupled to the first position sensor and the second position sensor; and
a power electronics module electronically coupled to the ECU and electrically coupled to the first, second, third, and fourth coils.

21. The thermodynamic apparatus of claim 17, wherein each of the first and second armature comprises:
first and second pole pieces coupled to the shaft; and
an annular permanent magnet with a first face of the permanent magnet abutting a face of the first pole piece and a second face of the permanent magnet abutting a face of the second pole piece, wherein:
the first pole piece is separated from the second pole piece; and
the first pole piece, the second pole piece, and the permanent magnet are magnetically isolated from the shaft.
